(19) United States
(12) Patent Application Publication
(10) Pub. No.: US 2010/0088096 A1
(43) Pub. Date: Apr. 8, 2010

(54) Hand held speech recognition device

(76) Inventor: Stephen John Parsons, Toronto (CA)

Correspondence Address: DOWELL & DOWELL P.C., 103 Oronoco St., Suite 220, Alexandria, VA, 22314, US

(21) Appl. No.: 12/285,370

(22) Filed: Oct. 2, 2008

(51) Int. Cl. G10L 15/26; G06F 3/041

(52) U.S. Cl. 704/235; 345/173

(57) ABSTRACT

A hand held device is used for interactively converting speech into text with at least one speaker. The device includes: a screen for displaying text; at least one voice input source for receiving speech from a single speaker; a sound processor operably connected to the voice input source; a storage device capable of storing an operating system, a speech recognition engine, speech-to-text applications and data files; a power source; a navigation system; and a control system operably connected to the screen, each voice input source, the storage device, the power source and the navigation system.

### FIELD OF THE INVENTION

This invention relates to speech recognition devices and in particular hand held speech recognition devices.

### BACKGROUND OF THE INVENTION

Many of the deaf community need to communicate on a daily basis but have no easy way of doing so. This is particularly true for deaf people that have grown deaf as they have aged since typically they have no understanding of conventional sign language nor do they have the inclination to learn it. In addition, in most cases, these people have a limited understanding and comfort level of today's complex technologies.

There are a number of technical limitations in regard to devices current on the market. Specifically, at the present time, all PDA (personal digital assistant) units currently on the market utilize processors that are less than 1 GHz processing speed. As well, all existing PDA units that utilize Windows MOBILE or CE operating systems do not offer speech-to-text speech recognition engines. Further, PDAs that use proprietary operating systems do not support speech engines. No PDA or cellular phone offers speech recognition engines for speech-to-text. Mobile processors greater than 1 GHz require significant cooling to dissipate heat generated by the processor. Mobile processors greater than 1 GHz have significant power consumption requirements that are not available in a small package that will offer acceptable battery life. Similarly, all of the above is also true for phone type devices such as Blackberry, Cleo's and similar products. As well, microphones built-in to existing PDAs and cellular phones are not of a high enough quality or of the type required for accurate speech recognition. No PDA or cellular phone has high fidelity sound processors to provide superior speech recognition accuracy. PDAs and Cellular phones offer multiple functions but do not provide speech-to-text speech recognition. Currently the existing technologies offer recording of wave files to be transferred to a PC (personal computer) for conversion.

In contrast existing portable PCs are too big to fit in a user's pocket and hence impractical for this application. New micro PCs do not have a simple application that provides the same function as the device of the present invention. Sony VAIO—UX™ unit is not fast enough with a processor speed of 1.33 GHz being the fastest they offer. Samsung Q1™ has a processor speed of 1 GHz and memory of 1 Gb and is too big to fit in a user's pocket. The OQO™ model 1 has a processor speed of 1 GHz and the Model 2 is a 1.5 GHz processor. This is still not fast enough for acceptable response for a user. Memory is also not enough at 1 Gb respectively. The device of the present invention requires a minimum of 1.5 Gb but will provide better performance with 2 Gb.

Accordingly it would be advantageous to provide a device that is specifically designed to be a single purpose device. The present invention is a convenient, easy-to-use, pocket sized communications tool. The differentiating factor between the present invention and other products on the market is its sheer simplicity. The user can simply turn it on and he/she is ready to go.

Preferably the present invention will have more power, performance and capabilities than anything on the market today. The design philosophy for the product is to use industry standard components where feasible. Only missing components will be created. For example, the software application is designed to operate with any speech recognition engine and can use existing hardware platforms such as PDA's (person digital assistance) and cellular phones when they become technologically ready. Currently, the product is designed to run on XP Embedded and will evolve to take advantage of future technologies. It will be appreciated by those skilled in the art that as technology changes and improves the components may change while staying within the overall design of the present invention.

The device of the present invention can also be deployed in relation to services that a deaf person would want to use on a daily basis, services such as doctors, banks and pharmacies. The device could also provide Emergency Services with a method of communicating with people who have no way of hearing them. Either the subject cannot hear or there is an obstacle preventing that person from hearing. In an enhanced device of the present inventions the devices will be able to communicate with each other.

The present invention has a custom operating system specifically designed for its single purpose. This will remove the current tendency of generic operating systems to reconfigure themselves without reason or warning, thereby not being user friendly.

Further, there were a number of technical challenges to overcome in regard to the design and implementation of the present invention. Specifically an operating system that provides support for the speech engine is Windows XP. This currently is available in embedded form but is not offered on any PDA or cellular phone. A new single purpose device must be specifically designed to support Windows XP so that the application of the present invention can also be embedded in such a unit.

Using the Embedded XP version allows for the design of the unit to use flash memory. This provides better performance required by the application and offers much lower power consumption. This small form factor allows the development of a pocket-sized device.

The closest existing technology is the OQO model 2. The OQO is a pocket size unit and has a high definition sound processor not offered in other similar devices. The performance of the OQO however is still too slow for acceptable usability. With a 1.5 GHz processor and only 1 Gb of memory, the OQO also has special requirements for heat dissipation. It has a built-in fan that is thermally adjusted based on the sensed temperature of the unit. This creates noise problems for the built-in microphone and the current noise-cancelling technologies cannot accommodate these variations in speed and noise frequency. The above performance features require a large battery thus making it difficult to build a smaller unit with the desired processing power and memory.

All existing PDA and cellular phones currently on the market have insufficient processing power and memory to support the desired application. This combined with the battery and performance requirements makes it necessary to design and build a custom unit with acceptable response and throughput.

The application is designed to be platform independent and also speech engine independent. This means that when more suitable operating systems and speech engines come along, the software can be adapted to utilize them.

Current small devices that offer speech recognition only support command or phrase speech recognition. Their performance is limited and therefore cannot support the complexities of continual speech-to-text.

Most PDAs and cellular phones currently on the market provide microphones but they do not typically address the requirements for speech recognition. The present invention will provide microphone technology conducive to speech recognition, thereby significantly improving accuracy.

### SUMMARY OF THE INVENTION

The present invention relates to a hand held device used for interactively converting speech into text with at least one speaker comprising: a screen for displaying text; at least one voice input source for receiving speech from a single speaker; a sound processor operably connected to the voice input source; a storage device capable of storing an operating system, a speech engine, speech-to-text applications and data files; a power source; a navigation system; and a control system operably connected to the screen, each voice input source, the storage device, the power source and the navigation system.

In another aspect of the invention there is provided a method for using an interactive voice recognition system having an operating system, device drivers, a speech engine and a speech-to-text application for use in a hand held device comprising the steps of: starting the hand held device and automatically loading the operating system, device drivers, the speech engine and the speech-to-text application; receiving at least one speaker profile; loading speaker preferences associated with the received profile; detecting speech and convert the speech into text based on the loaded speaker preferences; and displaying the text.

Further features of the invention will be described or will become apparent in the course of the following detailed description.

### BRIEF DESCRIPTION OF THE DRAWINGS

The invention will now be described by way of example only, with reference to the accompanying drawings, in which:

FIG. 1 is an illustration of the assistive hand held device of the present invention, showing the various peripheral devices that may be connected to the present invention;

FIG. 2 is a detailed illustration of the internal components of the present invention (the hardware) showing the preferred configuration of the present invention;

FIG. 3 is a further breakdown of the motherboard for the present invention that is constructed in accordance with the preferred embodiment of the present invention;

FIG. 4A, B, C, D, E, F are a flow chart of the software for running the hand held device of the present invention;

FIG. 5 is an image of the sample speaker screen in the normal mode of operation of the present invention;

FIG. 6 is an image of the speaker selection screen of the present invention;

FIG. 7 is an image of the main menu screen of the present invention;

FIG. 8 is an image of the speaker profile screen of the present invention;

FIG. 9 is an image of an example of a user-training screen of the present invention;

FIG. 10 is an image of an example of a preferences screen of the present invention;

FIG. 11 is an image of an example of another preferences screen of the present invention showing saving both text and voice;

FIG. 12 is an image of an example of a further preferences screen of the present invention showing group members;

FIG. 13 is an image of an example of a utilities screen of the present invention;

FIG. 14 is an image of an example of a settings screen of the present invention; and

FIG. 15 is a front view of an alternate embodiment of the assistive hand held device of the present invention.

### DETAILED DESCRIPTION OF THE INVENTION

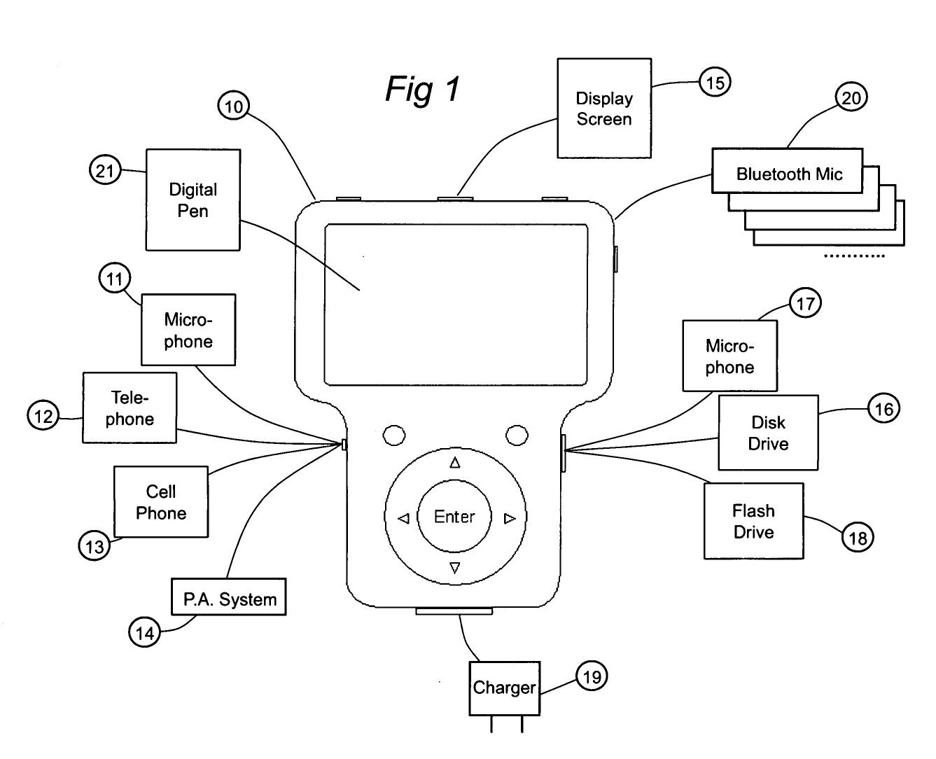

Referring to FIG. 1 an example of one embodiment of a hand held speech recognition device is shown generally at 10. FIG. 1 illustrates examples of possible peripheral devices that may be attached to interact with the hand held speech recognition device 10 of the present invention.

Specifically an external microphone 11 may be connected to the present invention through the Audio In port 40. Preferably the microphone 11 is a high quality microphone that includes noise-cancelling characteristics consistent with a unidirectional microphone or a microphone array.

Alternatively a standard telephone 12 having an audio jack for a headset may be connected directly to the Audio In port 40 of the hand held speech recognition device 10. This will allow the user of the present invention to understand the person at the other end of the phone. As with all input sources, the speaker must train the speech engine so that the speech-to-text conversion is as accurate as possible. A cellular phone 13 having an audio jack for a headset may be connected directly to the Audio In port 40 of the present invention 10. This will allow the user of the present invention to understand the person at the other end of the phone. As with all input sources, the speaker must train the speech engine so that the speech-to-text conversion is as accurate as possible. A Public Address system 14 may also be connected to the device of the present invention 10. This will allow the user to participate in a meeting or seminar where the speaker uses a microphone to make his/her presentation and there is an audio source from the P.A. System. As with all input sources, the speaker must train the speech engine so that the speech-to-text conversion is as accurate as possible.

An external display screen 15 may be connected to the device of the present invention 10 via the Video Out port 41 so that the user may use a larger screen. Preferably the display screen 15 would be connected by way of an industry standard video connection. An external disk drive 16 may be connected via a USB port 42 that enables the transfer of objects to and from the device of the present invention 10. This can be used to maintain the system as well as to transfer specific files that a user may wish to use in the training of the system. The USB port 42 may be used to connect a microphone 17 to the device 10. The device 10 may accommodate various microphone input connections. Preferably the microphones 17 have noise-cancelling characteristics consistent with a unidirectional microphone or a microphone array. The connection of a flash drive 18 via a USB port 42 enables the transfer of objects to and from the present invention. This can be used to maintain the system as well as to transfer specific files that a user may wish to use in the training of the system.

A charger 19 is provided for charging the battery pack when the present invention is configured with a battery pack. The charger may be for standard house VAC or a car adapter. The charger is connected to the device 10 via the Charger port 43.

One or more Bluetooth headsets 20 may be used to communicate with the present invention. Multiple Bluetooth headsets 20 allow for a group of people to converse with the user. The application supports multiple sources of speech converted into the same text file. As with all input sources, the speaker must train the speech engine so that the speech-to-text conversion is as accurate as possible.

Preferably the screen 33 allows for navigation and input by digital pen 21 and/or by touching the screen. The digital pen 21 is used to input characters via a virtual keyboard when the system calls for a speaker name or a new word is to be added to the database.

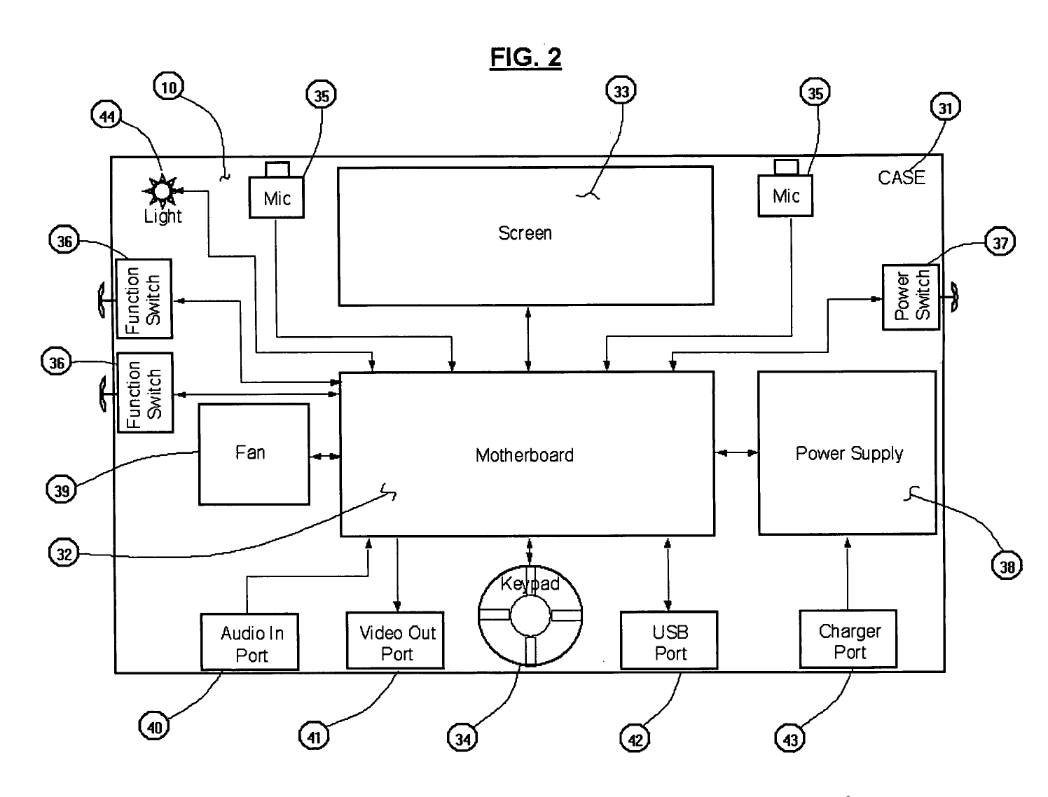

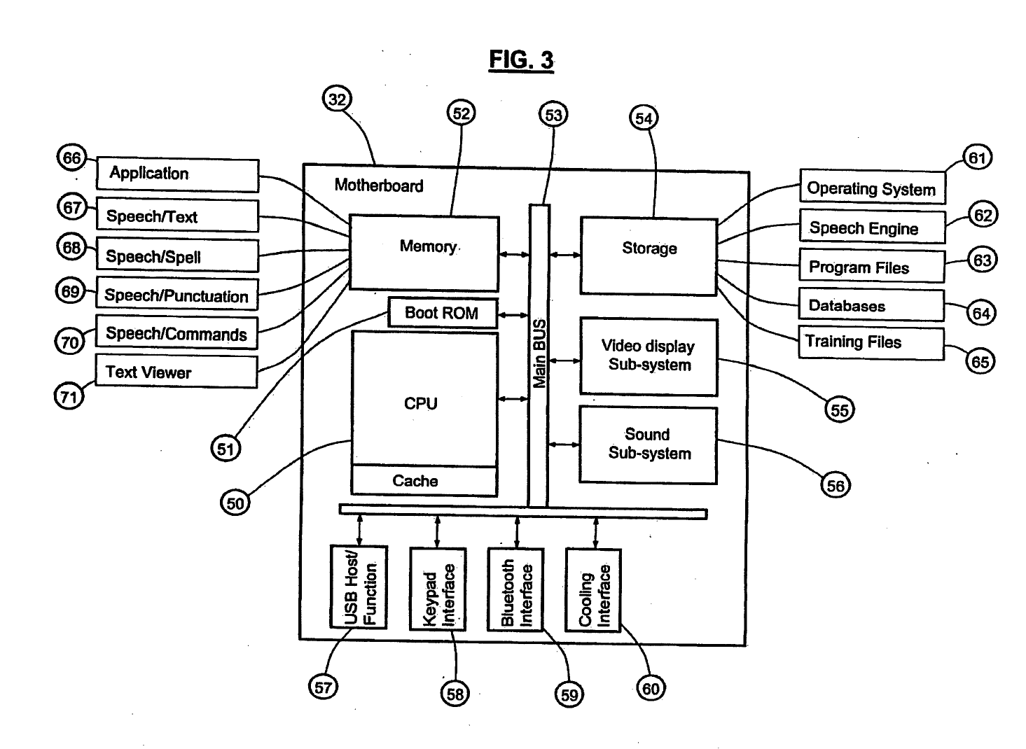

Referring to FIG. 2, the internal components of the device 10 are contained in the case 31. All components are specifically designed and constructed in accordance with the preferred embodiment of the present invention. The case is of a size appropriate to fit in the palm of the user's hand and fit in the user's pocket. It is made of high impact plastic and will be offered in any number of shapes, sizes and colours. Preferably, the motherboard 32 is designed and constructed specifically for the assistive hand held appliance that represents the specific embodiment of the present invention. Preferably its circuit board uses the latest in surface mount technology and is described in more detail below in relation to FIG. 3. The screen 33 is incorporated into the device of the present invention to display the application in accordance with the preferred embodiment of the present invention. Preferably the screen will be a touch screen or digital pen enabled and can be of various sizes and pixel densities. The screen may be black & white or colour.

A keypad 34 is provided as one of the input methods for this device. Preferably keypad 34 has five keys specifically for navigation and control of the application. For example, the five keys will be used for curser control and select or enter as their main functions. When in the normal mode of operation the ‘Enter’ button is used to turn the microphone on and off. This function is provided to mute any voice input from either the internal microphone array or any external audio source. Muting the input will prevent any sound from entering the speech engine. This will greatly improve the accuracy of the speech engine thereby allowing the speech engine to “settle down” or pause. This switch will prevent voice input from all sources including the internal microphone array, any external microphone, standard or cellular telephone as well as wireless devices such as a Bluetooth headset.

Two or more microphones 35, forming an array, provide inherent noise-cancelling capabilities. Preferably, the microphones are of high quality, unidirectional and will have the characteristics optimized specifically for the human voice.

Two function switches 36 are provided to assist the user in navigation of the system. The function for each function switch will change for each screen presented to the user. The power switch 37 is provided to turn the power on and off in the present invention. It also starts up the device when it is in hibernation or standby mode. A power supply 38 is provided to power the device 10. Power can be supplied to the device through multiple methods. It can be configured to use standard batteries or rechargeable batteries or it can be offered with an internal battery pack that can be recharged by an external charger.

A cooling fan 39 is housed in the device and its speed is controlled by a thermal sensing subsystem. This greatly reduces the heat generated in such a small yet powerful device that may cause the device to fail due to overheating.

Audio In port 40 is provided to allow the connection of any type of audio device such as a microphone, standard or cellular telephone or input from any other audio source such as a Public Address system. The Audio In port is configurable for the type of input device being used so as to match the input characteristics for that device. Video Out port 41 provides the capability to connect the device to an external video screen. It is configurable for the type of display that is to be used. USB port 42 is provided for connection of many different types of peripheral devices that may be used with the present invention. A USB wireless microphone may be connected via this method. It also may provide connection to a network for the present invention software maintenance by downloading or uploading information necessary for that maintenance. The USB port is also provided for connection of an external disk drive again to provide the capability to maintain the system. It will also be used to upload custom training text files to be used in the training of the speech engine. This may be done by the use of a Flash drive. Charger port 43 is provided for connection of a battery charger for the present inventions configured with a rechargeable battery pack. A light 44 is provided to show when the present invention has the power turned on. The light will be green when the present invention is turned on and ready to be used. When the user presses the microphone switch to activate the microphone the light will turn red indicating it is accepting input to the speech engine.

FIG. 3 is an illustrative representation of the motherboard constructed specifically for the preferred embodiment of the present invention. Preferably, the printed circuit board uses the latest technology. A high speed Central Processing Unit (CPU) 50 is selected specifically for the performance that it offers with respect to the embodiment of the present invention. It may consist of one or more processors. It should be at least 1.5 GHz in a 32 bit architecture or an equivalent or faster in a 64 bit or higher architecture. Since the speech engine is extremely processor intensive this processor should be as fast as is available for a mobile application and battery powered appliances so as to provide the user with the best experience possible. The processor should have a large cache preferably 1 Gb or higher.

A Boot ROM 51 is required to ‘boot up’ the system when the power is turned on. This initiates all system hardware and launches the operating system and all programs that represent the embodiment of the present invention. High speed memory 52 is used to provide high performance for interfacing with both the CPU 50 and storage 54. Preferably, there should be at least 2 Gb of memory again to provide good performance as the applications swap files between memory, CPU and storage. The memory 52 is large to minimize the swapping out of memory to storage 54 so that maximum performance is achieved.

A high speed Main BUS 53 is used to provide maximum performance for the best user experience possible. System bus speeds should be as fast as is available. Currently technology is at 533 MHz for high performance mobile units but the higher the better when moving data between storage, memory and the processor for this application.

Storage 54 will be flash type providing reduced power consumption compared to traditional disk drives. It also provides significant improvements in Mean Time Between Failure (MTBF) thereby improving life in the product. Flash drives also offer smaller storage capacities at much lower cost. They also allow the device of the present invention to be much smaller than those having traditional disk drives. Finally the flash drive offers better performance than traditional disk drives by providing virtually no lag time. Storage may be as small as 2 GB for storage of the. Operating system, program files, data files and training text files.

The video display subsystem 55 supports the internal touch screen and digital pen display. It also supports the connection of an external monitor as discussed earlier. The sound subsystem 56 is a key component to the success of the preferred embodiment of the present invention. It offers high fidelity sound with noise-cancelling technology such as is offered with the SoundMAX. This sound processor is specifically designed to support high accuracy for speech recognition applications and provides support for a microphone array. It also includes noise-cancelling software to minimize ambient background noise again providing a forum for better accuracy. Input to the sound processor is from any one of the audio source inputs described herein.

The USB host/Function 57 allows connection of peripherals that the system supports. This includes peripherals for uploading and downloading files and programs needed to maintain the device of the present invention. It also provides a method for the user to transfer files that can be used in training the speech engine for the specific intended use.

The keypad interface 58 allows the simple keypad to perform all the navigation and selection functions it is intended to perform that represent the preferred embodiment of the present invention. The Bluetooth interface 59 provides connection for multiple Bluetooth headsets to interact with the application in the manner in which represents the preferred embodiment of the present invention. The cooling interface 60 provides thermal sensing fan control for the internal fan. It is required for cooling since high-speed processors and large capacities of memory generate significant amounts of heat that must be dissipated. Cooling channels and vents are incorporated into the case.

The operating system 61 is configured specifically for the preferred embodiment of the present invention and is stored in the Flash storage. It has only the functionality and capability required for its purpose. This is done to maximize the performance of the system. Currently, the XP Embedded operating system supports Microsoft Speech Engine. Other Operating Systems such as Microsoft's Mobile and CE do not support the MS Speech Engine for speech-to-text. The application is designed to be platform independent so as to be capable of running on any operating system.

A speech engine 62 is utilized as the speech converter. Microsoft Speech Recognition is used as the preferred embodiment of the present invention. The application is designed in such a manner as to be capable of using any speech recognition engine. All languages offered by the speech recognition engine are offered.

Program files 63 are stored in the Flash storage for use in the application for the preferred embodiment of the present invention. Programs are launched and loaded as required into the memory 51 and run in the CPU 50.

A database 64 of files is held in the Flash Storage. All necessary hardware drivers are stored here. Configuration files for each user are stored here. Files such as user speech profiles are also stored here. User output files that can be retrieved for viewing at a later time are also stored here. Similarly, training files 65 are stored here for access by the training programs. The training files 65 may be the files delivered with the speech recognition engine and also custom files created specifically for the application of the present invention.

The system application 66 is loaded into memory 51 automatically once the present invention has completed its initial boot up. The system application is designed to be platform independent meaning that it can operate on any operating system. For example it could operate on a Cellular phone or a Personal Digital Assistant if and when those devices support a speech-to-text speech recognition engine and the referred to equipment has sufficient performance to support a speech engine. The speech-to-text converter 67 is launched during system boot up and is placed into memory 51 making it available for the application upon demand. It is loaded into memory 51 to minimize swapping in and out of storage thereby maximizing system performance. The speech-to-spell converter 68 is loaded into memory 51 such that it is available when the user needs to spell a word that the speech-to-text converter does not understand as the word may not exist in the existing database of known words. It is loaded into memory 51 to minimize swapping in and out of storage thereby maximizing system performance. The speech-to-punctuation converter 69 is loaded into memory 51 as is required by the application. It provides the capability to add punctuation to the text output by saying the punctuation requested. It is loaded into memory 51 to minimize swapping in and out of storage thereby maximizing system performance. The speech commands converter 70 is loaded into memory 51 as is needed to be available when called for by the user. It is loaded into memory 51 to minimize swapping in and out of storage thereby maximizing system performance. A text viewer 71 is loaded into memory as is required to view text output files that have been saved by the system. This allows the user to review stored files as is required. These files are stored in a RTF format to allow any available off-the-shelf product, such as Word™, to be used as the viewer.

### Software

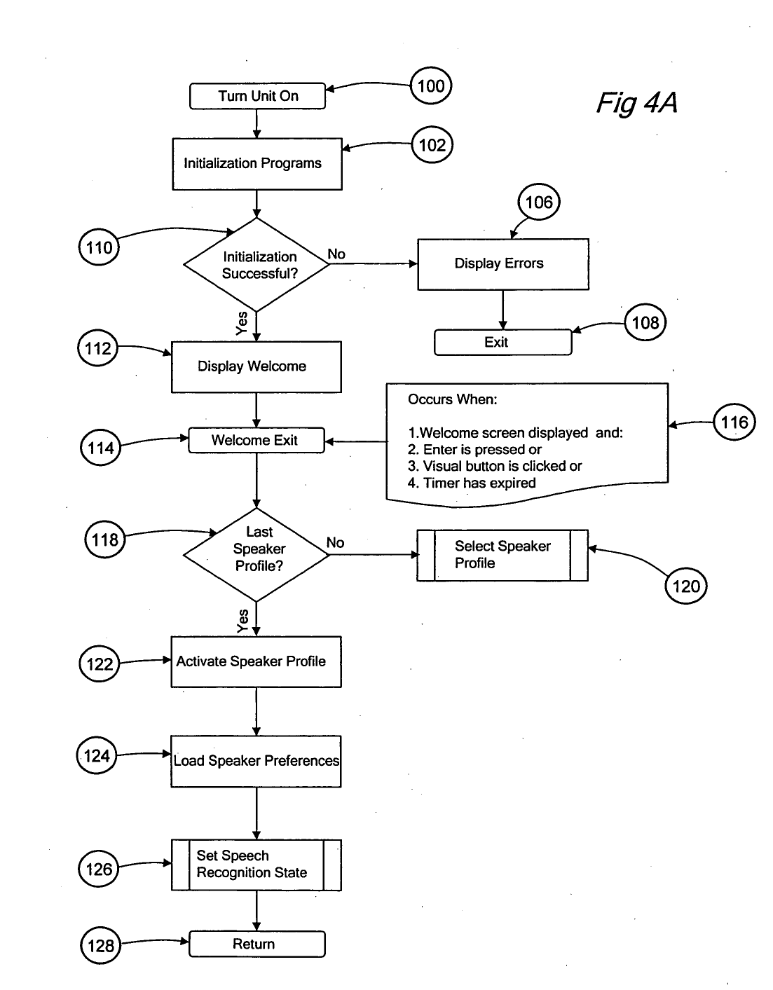

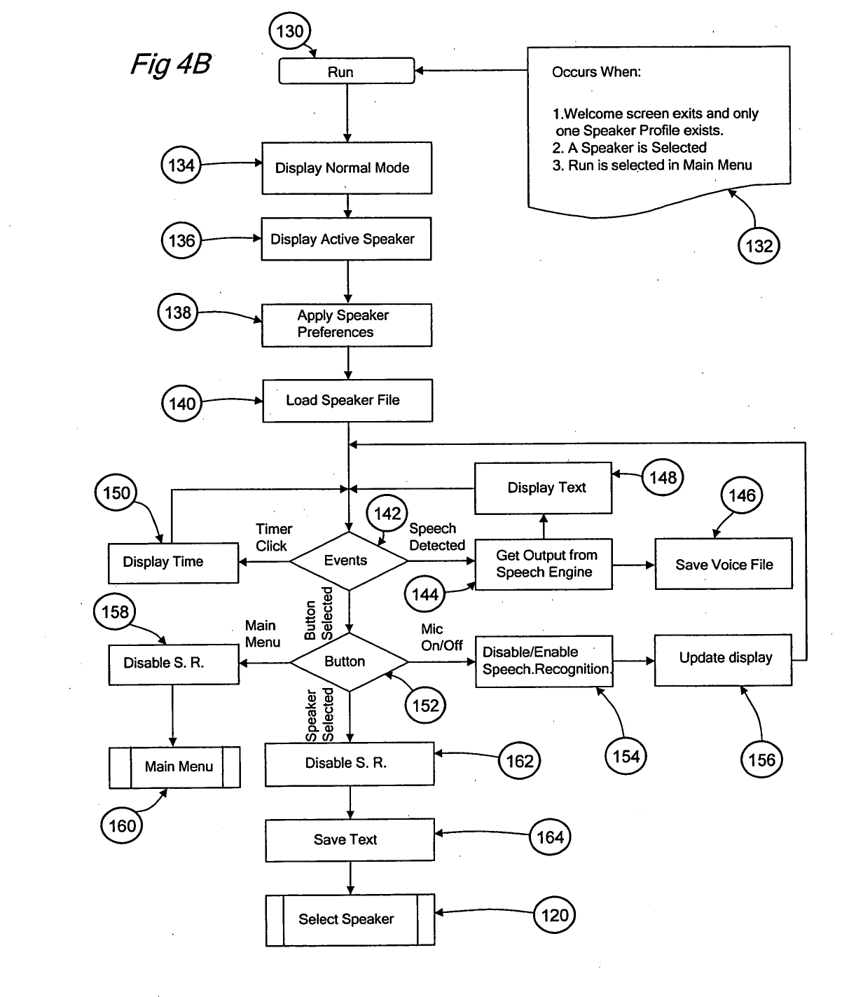

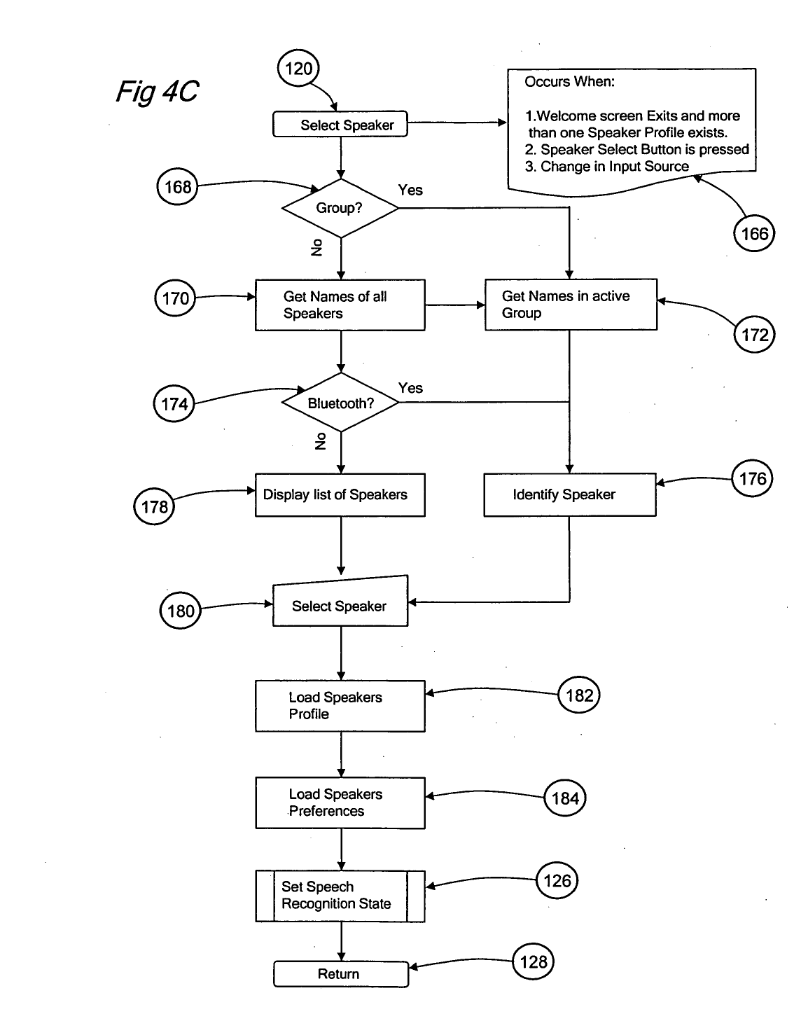

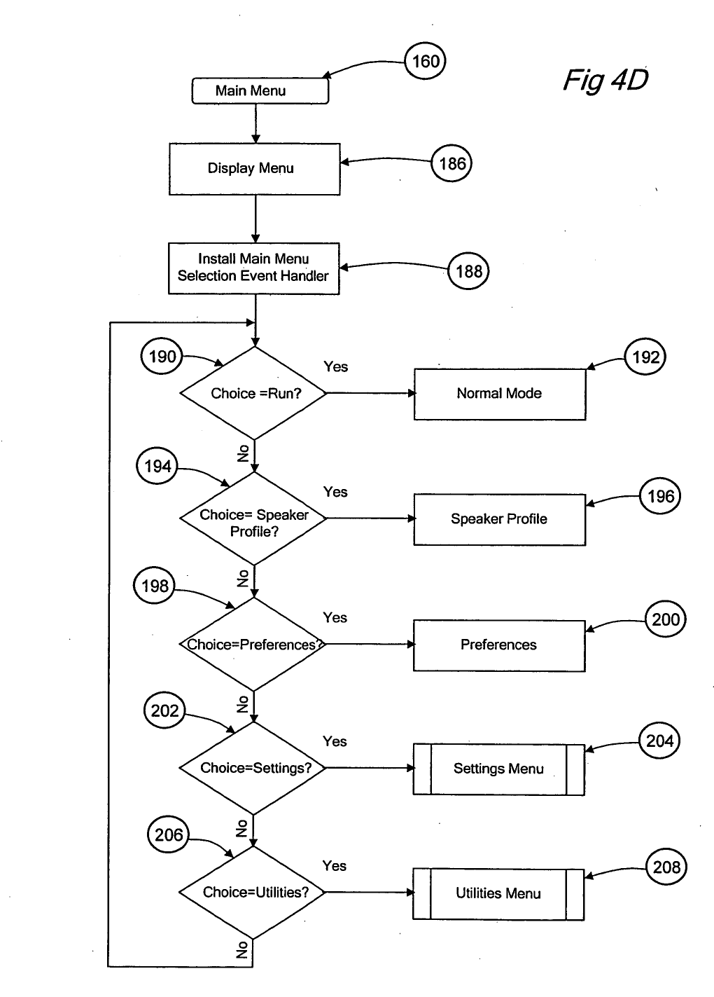

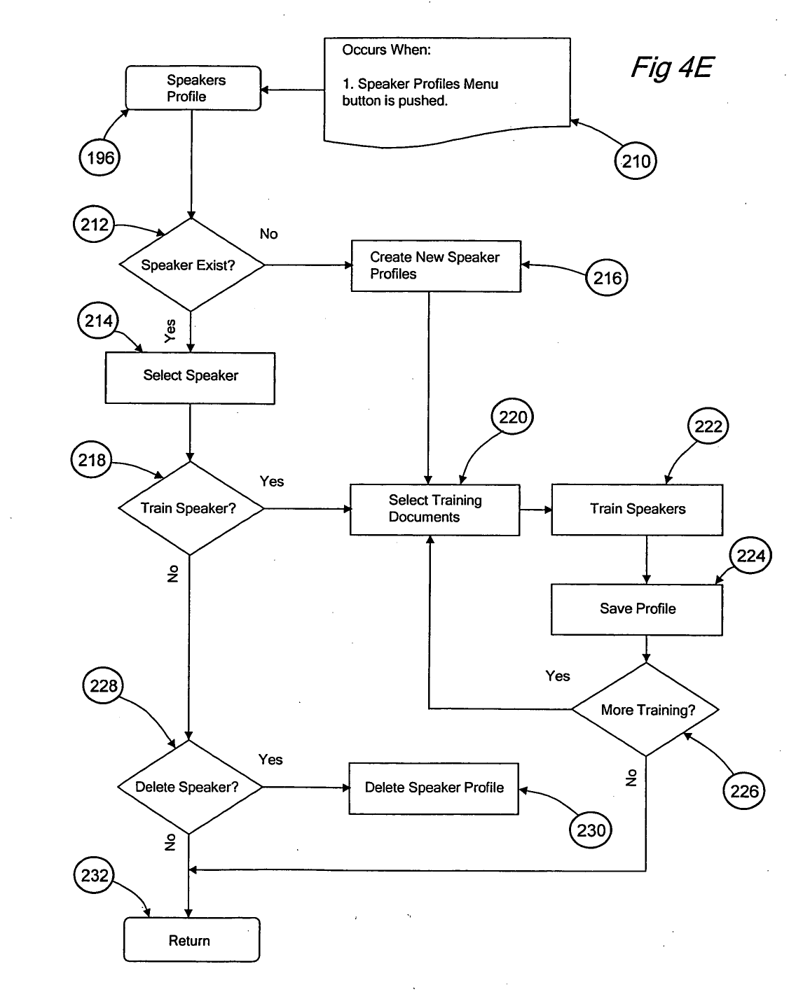

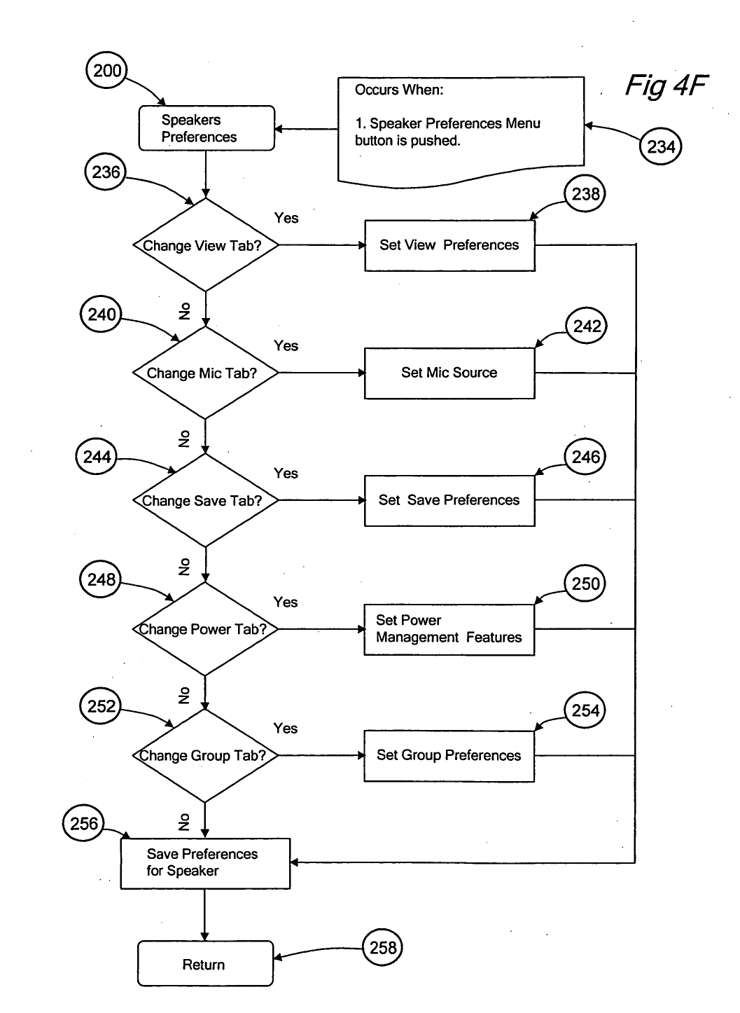

Referring to FIGS. 4A to 4F there is provided a high level description of the software as it relates to the embodiment of this invention.

FIG. 4A shows the start-up portion of the software. The software starts when the User turns the Unit's power on 100. Then the system's Initialization Programs are launched 102 that start up all necessary systems, device drivers and programs to make the device functional. The system goes through a series of checks 110 to make sure that the system is functioning properly. Any errors during this boot-up cycle are displayed 106. If there are errors detected then the application exits 108 and the User starts the process again. For units that are multifunctional such as a phone or PDA, this same sequence will happen once the system application is launched, except if errors are found then it will only exit the application.

If all systems are functioning correctly then the Welcome screen is displayed 112. Once the Welcome screen is displayed the User can enter the application based on a number of criteria 116: the Enter button on the Unit is pressed, the button on the screen is selected or the timer expires. The application then starts the set-up sequence and exits the Welcome screen 114.

The system checks the ‘Last Speaker Profile’ 118 setting found in the Save Preferences file to see if it is to load the last Profile on start-up. The default is to load the last profile at start-up. If the Last Speaker Profile option is not selected then the User is directed to select a Speaker Profile from the Select Speaker window 120. The Speaker Profile will be loaded 122 and made active either the last Speaker Profile or a selected Speaker Profile. The Speaker Preferences are loaded 124. The system is ready to accept output from the Speech Recognition engine 126. It is now ready to display the Normal Mode of operation 128.

The normal mode of operation is shown generally in FIG. 4B. The Normal Mode is where the User will spend most of their time reading the text output from the speech engine. The Normal Mode 130 of operation is started based on the following criteria. The requirements 132 to run the Normal Mode of Operation occur when the Welcome screen is exited, a Speaker Profile has been selected or Run has been selected from the Main Menu. The Normal Mode screen is displayed 134. The active Speaker Profile name is displayed 136 at the top of the application window. The active Speaker Preferences are applied 138. Any file the Speaker may have is loaded 140. The Event Manager 142 checks for any event that may have happened. If an event is recognized, the process associated with that event is triggered.

When speech is detected 144, the output from the Speech Recognition engine is converted to text. The text is displayed 148 in the Normal Mode application window, 134, based on the Speaker's View Preferences. The voice is recorded 146 and filed if the system is selected to record them based on the preferences.

The Timer Click 150 updates the on-screen time, displayed if the View Preference is set to display it. When a button is selected from this screen, the Button Event Manager 152 initiates the appropriate process to take place. The Microphone is turned on or off by pressing the ‘Enter’ button on the device. This disables or enables 154 the Speech Recognition engine. The display is updated 156 to show the state of the microphone being on or off. When the ‘Main Menu’ button is selected the Speech Recognition engine is disabled 158. The Main Menu is displayed 160.

When the ‘Speaker’ button is selected the Speech Recognition is disabled 162. The text stored in the display file is saved 164. The Speaker Select window is displayed 120.

FIG. 4C shows the Select Speaker portion of the program. The Select Speaker program 120 is initiated when one of a number of criteria are met. The criteria 166 are: the Welcome screen exits and the ‘Last Profile’ setting is not selected in the Save Preferences, the ‘Speaker’ button is selected or there is a change in Input Source. An example of this is when multiple Bluetooth headsets are being used. The ID of the Bluetooth headset is detected and used to identify which associated Speaker's Profile to load.

The system can be used in a Group Mode 168 by selecting ‘Group’ in the Group Preferences tab. All the existing Speaker Profiles are scanned 170 to determine if the Bluetooth headset being used is in the system and can identify the associated Speaker. The names of the Speakers in the group are selected 172 and stored for display on the screen against their converted text. Group Mode allows each member of the group to have their speech converted to text and displayed in a single document in the Normal Mode application window.

When a Speaker is using a Bluetooth headset, the system will automatically identify them 174. The system identifies a Speaker by the Bluetooth ID number associated with their profile. Each member of the group is detected automatically by their source identification 176. If there is no ID match then a new Profile must be created and associated to that Bluetooth headset. When the system is being used in the Single Speaker Mode, all the Speaker Profiles on the system are displayed 178. If the Speaker is using a Bluetooth headset they will have been automatically identified by the system.

The selected Speaker Profile 180 is read from storage. The selected Speaker Profile is loaded 182. The Speaker's Preferences are loaded 184. The system is ready to accept output from the Speech Recognition engine 126. It is now ready to display the Normal Mode of operation 128.

FIG. 4D shows the main navigation portion of the application. The Main Menu is launched 160. The Main Menu is displayed 186 on the screen for the User to select one of the options presented. The Selection Event Manager 188 is loaded to execute the User's selection. Each of the selections navigates the User to various parts of the system. Select ‘Run’ 190 and the Event Manager launches that process. When the User selects ‘Run’, the system launches the Normal Mode program 192.

Select ‘Speaker’ 194 and the Event Manager launches that process. When the User selects ‘Speaker’ it launches the Speaker Profile program 196 where the User can create a new Profile, train a new or existing Profile or delete a Profile.

Select ‘Preferences’ 198 and the Event Manager launches that process. When the User selects ‘Preferences’ the system launches the Preferences program 200, where the User can select various preferences for: Viewing, Microphone source, Save settings, Power Management settings and Group settings.

Select ‘Settings’ 202 and the Event Manager launches that process. When the User selects ‘Settings’, the system launches the Settings Menu 204 where the User can select various settings for screen drivers, Microphone, Default and Speech Settings.

Select ‘Utilities’ 206 and the Event Manager launches that process. When the User selects ‘Utilities’ the system launches the Utilities Menu 208 where the User can find lists of saved text files by Speaker or by Date for viewing purposes. Also, new words can be added to the Dictionary and then the Speaker can pronounce the word for the system to remember.

FIG. 4E shows the Speaker Profile portion of the program. The Speaker Profile program 196, that maintains the speech recognition Speaker Profiles, is launched. Does the Speaker have a profile 212? If yes, the Speaker selects 214 their Profile from the drop down menu. If ‘New’ is selected 216, a new Speaker Profile is created for that Speaker and they are then taken through the training process.

The selected Speaker can further train their existing Profile by selecting the ‘Train’ button 218. Training 218 of a Speaker starts by selecting a document. Documents 220 can be the standard ones that come with the Speech Recognition engine or the Speaker can create custom training documents specific to the User/Speaker application requirements. By selecting a document the Speaker is taken through the training process 222. Training can be done an unlimited number of times. The more the Speaker trains the system, the more accurate it becomes. After the training process is finished the profile is saved 224. The Speaker is asked if they wish to do any ‘More Training’ 226. If further training is wanted then the Speaker is taken back to the beginning of the training process, 220 and starts again.

The selected Speaker Profile can be deleted 228 by selecting the ‘Delete’ button. The active Speaker Profile cannot be deleted. The Speaker Profile is confirmed to be deleted and is then deleted 230. If no further training is wanted, the Speaker is returned 232 to the Main Menu. Upon exiting the Speaker Profile program, the last trained Profile is loaded along with the Speaker's Preferences. The System is now ready to run with that Speaker Profile.

FIG. 4F shows the Speaker Preferences portion of the program. Speakers Preferences program 200 is launched when the Criteria is met. The criteria 234 for launching the Speaker Preferences, is selecting the ‘Preferences’ Menu button. The User can select any one of the tabs presented to set a Speaker's preferences.

The User may select the View tab 236. When the View tab is selected the User can set the attributes or preferences 238 for how they wish the application window Normal Mode, 134, to appear for that Speaker and how the text is displayed. The User can set fonts and select if they wish to have the time displayed and how it is to be displayed. The User can also decide how the text is scrolled on the screen in the application window Normal Mode, 134.

The User may select the Mic tab 240. When the Mic tab is selected the User selects the microphone source 242 for that Speaker Profile. If the Speaker is using an external source then the system walks the User through setting up the appropriate settings for that source. The User can also select whether the input source is active when the Unit starts-up.

The User may select the Save tab 244. Selecting the Save tab provides the User with save Preferences 246. Text and voice files can be saved on the system and retained for a period of time. Files will only be saved if Retention Days is set greater than zero. The User selects ‘Last Profile’ if the system is to start-up with the last active Speaker Profile.

The User may select the Power Management tab 248. The Power Management tab allows the User to set features for power management 250, including power consumption thereby maximizing battery life of the Unit.

The User may select the Group tab 252. The Group tab allows the User to configure and set group preferences 254 in regard to how the Unit is to operate with a group. It can operate in either a Single Speaker Mode or in a Group Mode. If ‘Group’ is selected, the User selects the members of the Group from the existing Speaker Profiles. All the selected Speakers are associated with that group. The Group Profile is given a name and is saved for future use. The speech from each Speaker is collected by the system and the converted text is displayed on the screen. Each Speaker is identified on the screen in sequence with their associated text.

The Speaker's Preferences are saved 256 when exiting the Preferences program. Thereafter the system returns the User to the Main Menu 258.

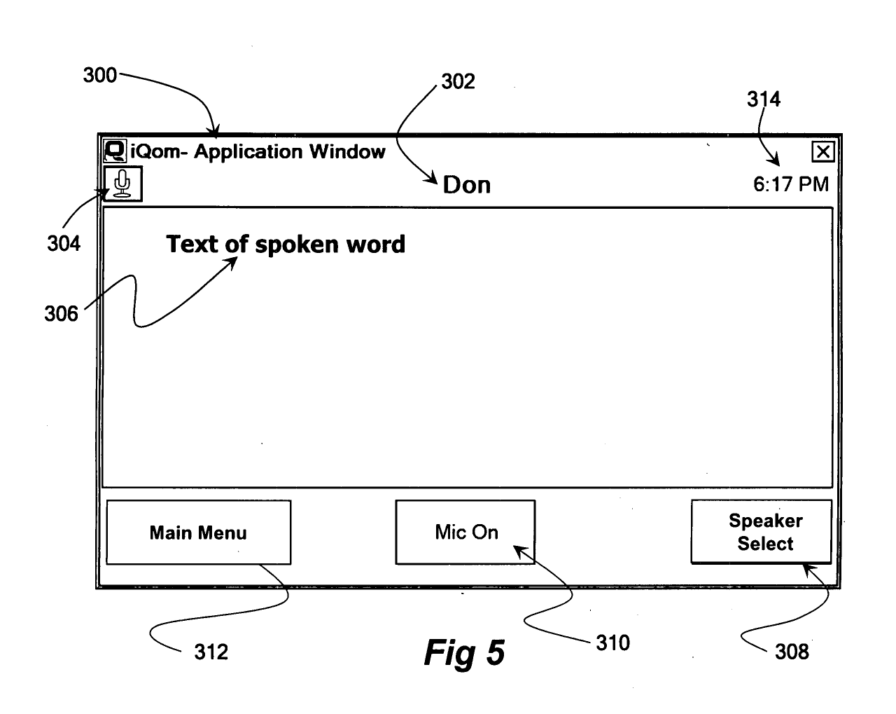

Samples of different screens that may be displayed are shown in FIGS. 5 to 14. It will be appreciated by those skilled in the art that these images may change both in quantity and quality depending on the base software. For example some of the screens that may be displayed are as follows, a welcome screen, a normal mode screen, a speaker menu screen, a main menu screen, a speaker profiles screen, an add new speaker screen, a speech settings screen, a voice training screen, a voice training window screen, a plurality of preferences screens, a plurality of utilities screens, a plurality of speaker training screens, a settings screen and a microphone wizard screen. The above list is merely a suggestion of some of the screens that may be included to make the device of the present invention easy to use and user friendly.

Specifically the Welcome screen is the initial screen presented to the User when the Unit's power is turned on. The system will automatically move to the next screen after a predetermined number of seconds or the User has pressed the ‘Enter’ button on the keypad.

The system herein has a number of different modes of operation. However, the normal mode of operation is the typical mode that will be used by a user. A user will typically stay in this mode most of the time. Once the system is set up, the user will not need to go out of this mode very often.

Referring to FIG. 5 a Normal Mode screen is shown generally at 300. The Normal Mode Application Window screen 300 will appear either after the Welcome screen, if the ‘Last Profile’ option in the Save Preferences is selected or it will appear after the User has selected the Speaker they wish to converse with. The name 302 of the active Speaker Profile is shown at the top centre of the screen. An icon 304 in the upper left hand corner of the screen indicates if the microphone is on or off. The User presses the ‘Enter’ button to turn the ‘Mic’ on and the Speaker then talks into the microphone. Their spoken words will appear as text 306 on the screen in real-time as the speech is converted. The properties of the text shown on the screen can be set for each individual Speaker thereby making it easier for the person to read the converted text as discussed below. From this screen the User can select another Speaker by selecting ‘Speaker’ 308. This takes the User to the Speaker Profiles screen where the User can pick a new Speaker Profile. The ‘Mic’ 310 should be turned off when the Speaker is not talking to prevent input. This helps the Unit from unnecessarily consuming battery power by preventing input to the Speech Recognition engine. The ‘Main Menu’ 312 takes the User to the Main Menu where the User can perform a number of different tasks. The time 314 is indicated at the right of the title bar for convenience. The User can select whether time is displayed or not.

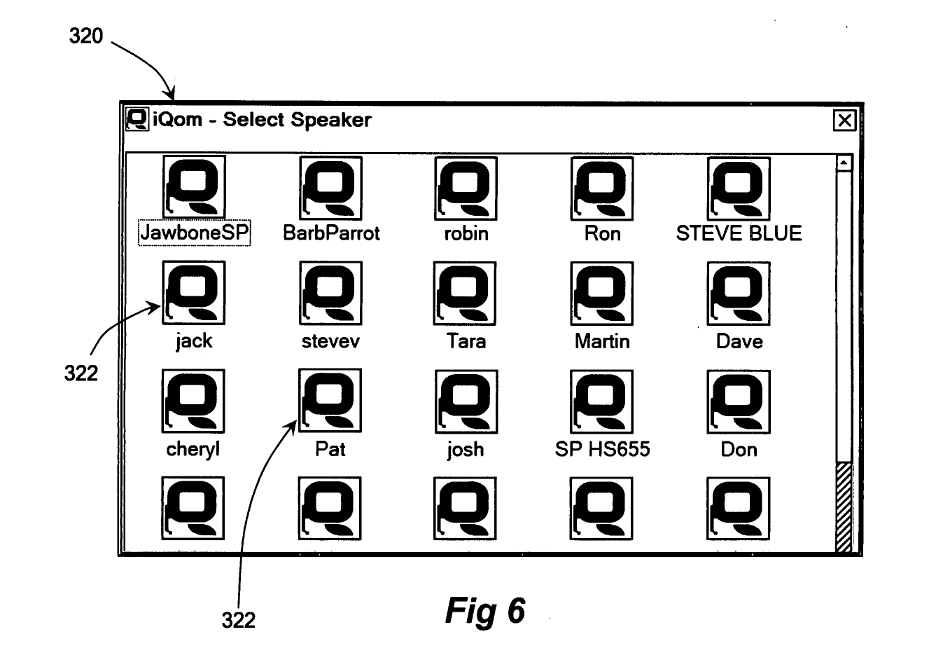

A sample Speaker Menu screen is shown at 320 in FIG. 6. The Speaker screen is the first screen to appear after the Welcome screen if the ‘Last Profile’ option is not selected on the Unit. The Speaker screen shows the Speaker Profiles 322 existing in the system. The User selects the Profile for the Speaker they wish to converse with by selecting the appropriate icon for that Speaker.

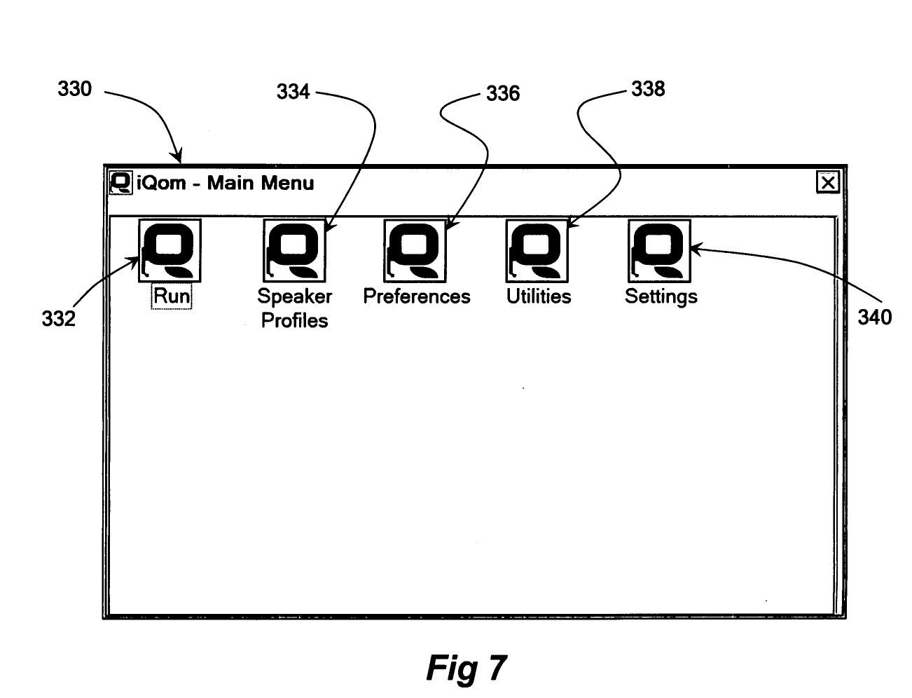

A sample Main Menu screen is shown at 330 in FIG. 7. The Main Menu provides navigation to all the major areas of the application. Selecting ‘Run’ 332 launches the Normal Mode of operation. Selecting ‘Speaker Profiles’ 334 allows the addition of new Speakers to the Unit. They can then train their profile prior to starting the Normal Mode. It also allows existing Speakers to perform additional training for their profile on the Unit. Profiles can also be deleted from this option. Selecting ‘Preferences’ 336 allows the User to create their Preferences for each Speaker Profile. It can create different views for the Normal Mode. It provides definitions for the type of microphone being utilized by the Speaker. It provides save options for text and voice, power options and group options for the Unit. Selecting ‘Utilities’ 338 provides the Speaker with the ability to add new words to the system and train them. It also allows the User to view text files saved by Speaker or by date. ‘Settings’ 340 provides system set-up options such as Video definition, microphone set-up and speech properties settings. It also allows the User to set up the defaults for preferences that are adopted for each new Speaker Profile.

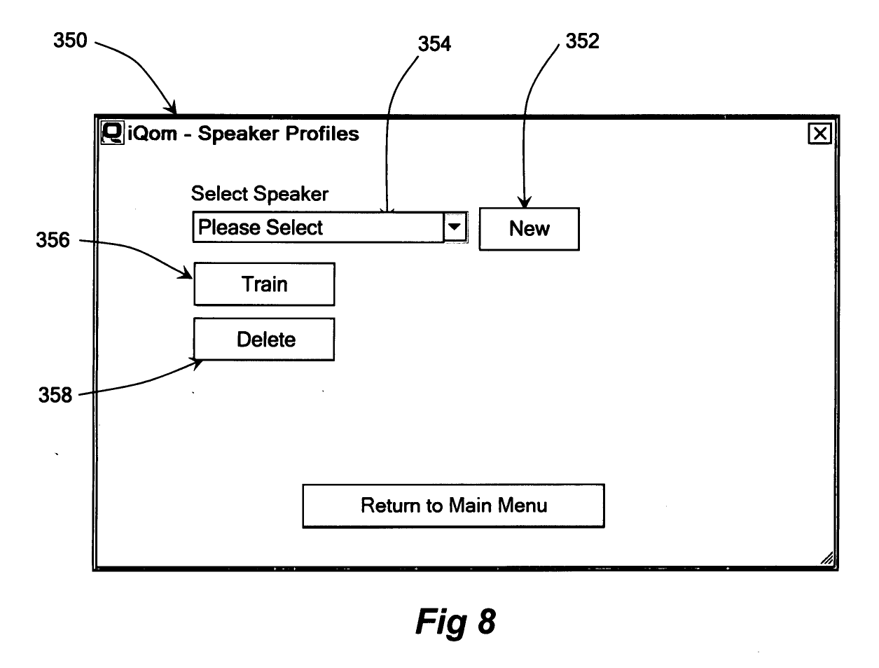

A sample Speaker Profile screen is shown generally at 350 in FIG. 8. Selecting ‘New’ 352 allows the User to create a new Speaker Profile on the Unit. The Speaker is then taken through the training process. Selecting an existing Speaker from the drop down menu 354 allows that Speaker to provide additional training by pressing ‘Train’ 356. The selected Speaker Profile can also be deleted from the Unit by pressing ‘Delete’ 358.

When a new Speaker is added the new name is input into the name field and then training may begin. If “Cancel” is clicked then the User is returned to the previous screen.

Preferably the Speaker can adjust the speech recognition engine for accuracy versus recognition response time. As well preferably background adaptation should be turned on to improve accuracy as the system is used more.

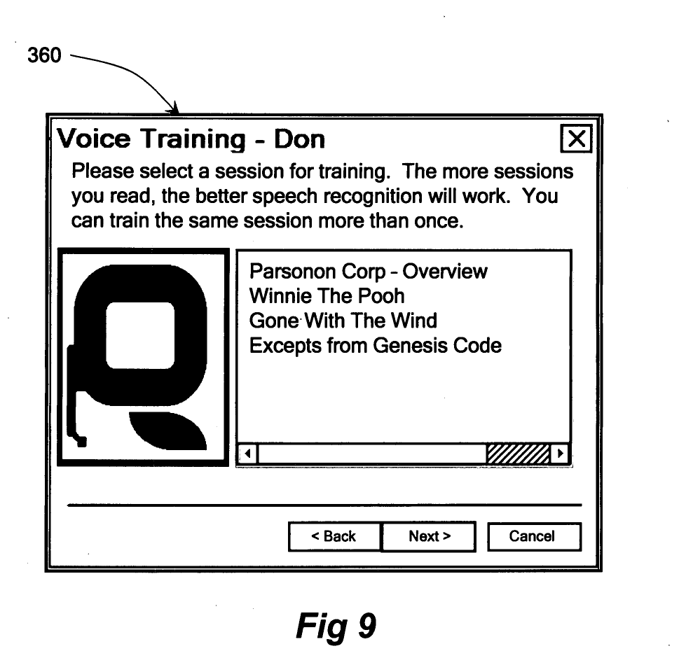

A sample Voice Training screen is shown generally at 360 in FIG. 9. The Speaker selects which passage they wish to read. The window shows the text that the Speaker should read to train the speech recognition engine. It is important that the text used for training is representative of the words, phrases and sentences intended for its use. Training an appropriate text will greatly improve the accuracy of the Unit. Custom text can be added to the device of the present invention for the application required. For example: for a bank clerk the text training document would include typical bank words, phrases and sentences such as:

a. Would you like to open a new bank account.

b. Make a withdrawal.

c. Buy some foreign currency.

d. Buy a GIC.

e. Apply for a loan.

By selecting the ‘More Training’, the Speaker can perform additional training that in turn will improve the accuracy of the Unit.

A sample Preferences screen is shown generally at 370 in FIG. 10. The ‘View’ tab 372 is unique for each Speaker Profile. The Font Window displays the current font information for the active Profile. A User selects the ‘Change’ button 374 to modify the font for the current active Profile. The User may select the font, style and size they wish to see the current Speaker's text presented on the screen. The User selects the ‘Display Time’ 376 if the User wishes to see the time on the screen. The User then picks how the time is to be displayed. The User selects how the User wishes to have the text scrolled on the screen by selecting ‘Line by Line’ 378 or ‘Full Page’ 380. Line by line scrolls up as new text is added to the bottom of the screen. Full Page presents a new screen after the current screen is full. In both cases, the scroll bar is shown once a full screen is reached to allow the User to review any of the previously recorded text. Selecting ‘Main Menu’ 382 saves all the changes to the Speaker Profile. Selecting the ‘Restore Default’ 384 button Will restore the Speaker Profile to the default settings that are found in the Settings menu under ‘Default’. Selecting ‘Cancel’ 388 does not save any of the changes made to the preferences.

The User also selects the type of microphone that the Speaker will be using. This selects the appropriate driver and input source for this device. For each type of microphone used, the Speaker must run the Microphone Wizard found in the Settings menu and also train a new Speaker Profile for that microphone. If ‘Internal’ mic is selected, then the internal array microphone will be used. The Speaker must speak into the front of the Unit. Similarly if the User is using an external microphone for the Speaker, then selecting ‘External’ will direct the User to select the input source of either Audio In or USB port. If the ‘Bluetooth’ is selected, the User is directed to the Bluetooth Settings window where the User creates a new connection with the Bluetooth headset for configuring the new Bluetooth. The User will pair the Bluetooth headset to the present invention. The Bluetooth headset's ID is then associated with that Speaker's Profile. ‘Other’ should be selected for sound sources other than a microphone. This can be from a standard telephone or cellular phone. It can also be from a sound source such as a public address system or similar source using the Audio In port or the USB port. When using this type of source, the input must be defined to the Unit.

Select the ‘Turn Mic’ on at start-up if the User wishes the Speech Recognition engine to accept sound from any source upon start-up of the Unit. ‘Restore Default’ sets the Unit's sound source to be the internal microphone.

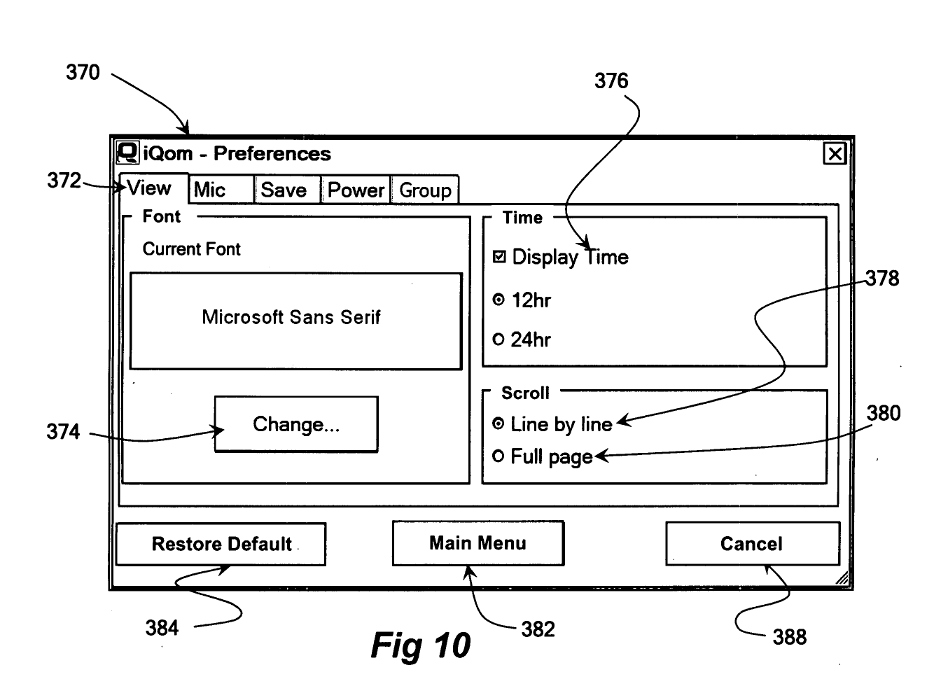

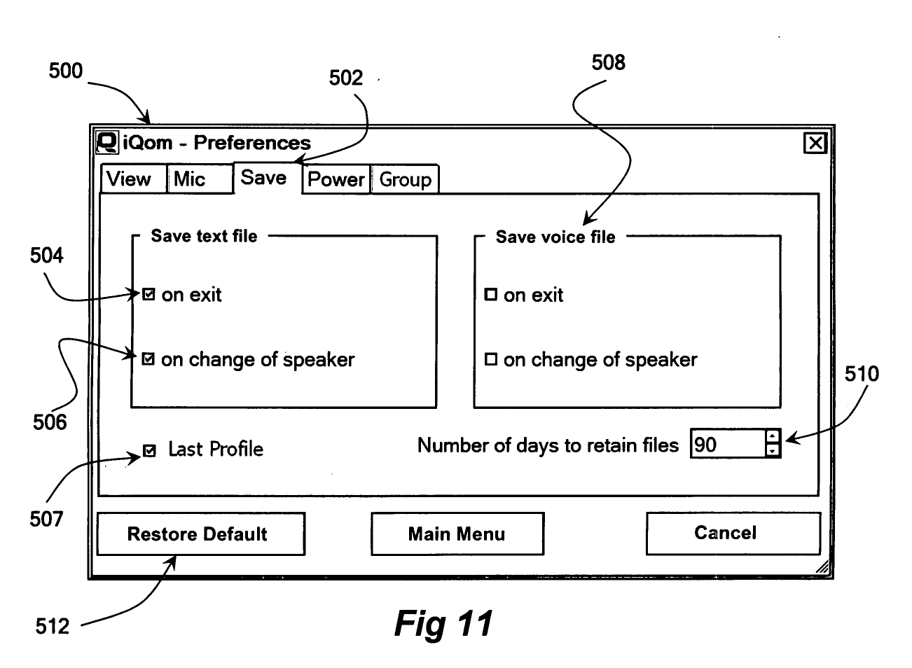

Another sample Preferences screen showing that system allows the User to save both text and voice files is shown generally at 500 in FIG. 11. The save function 502 is a system wide setting. Selecting ‘Save on Exit’ 504 will save the Speaker's text from their spoken words to a file that can be viewed later when the User exits the application. If this is not selected then the files will not be saved. Selecting ‘Save on change of Speaker’ 506 will automatically save a Speaker's text from their spoken words when the User changes Speakers in Single Speaker Mode. If this is not selected then the files will not be saved. Select Save voice files 508 if the User wishes to have the voice files for future review. This can be for clarification of converted text or for audit purposes. In one embodiment the text presented in the Normal Mode cannot be edited on the Unit. The files can be downloaded to a PC via the USB port for editing.

‘Last Profile’ 507 sets the Unit to load the last active Speaker Profile at start-up. If it is not selected, then the system launches the Speaker Select screen after the Welcome screen. If Save is selected then the ‘Number of days to retain files’ 510 should be picked. The system will remove the files after the number of days shown in the drop down menu. The system will not save files with the retention days set to zero. The ‘Restore Default’ 512 will set the Unit not to save files.

The User will set the Power Option settings that they wish to have the present invention operate under.

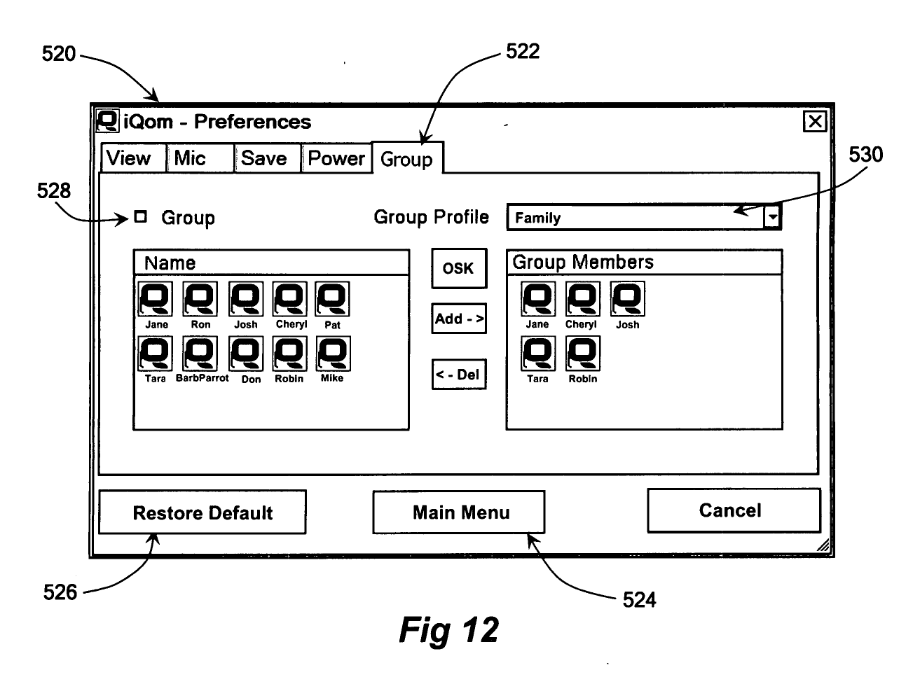

A further Preferences screen showing group members is shown generally at 520 in FIG. 12. If ‘Group’ tab 522 is selected then the present invention allows input from multiple Speakers. The User selects the members of the Group and gives that group a Name 530. Each Speaker is identified by the system and their speech is converted using that Speaker's Profile. The system then displays all the active Speaker's converted text to the screen identifying each Speaker by Profile name and saves the text to a single file. Selecting ‘Main Menu’ 524 saves the Group Profile if ‘Group’ 528 has been selected and the Unit is configured for group use. Selecting ‘Restore Default’ 526 sets the device of the present invention to operate with a Single Speaker Mode.

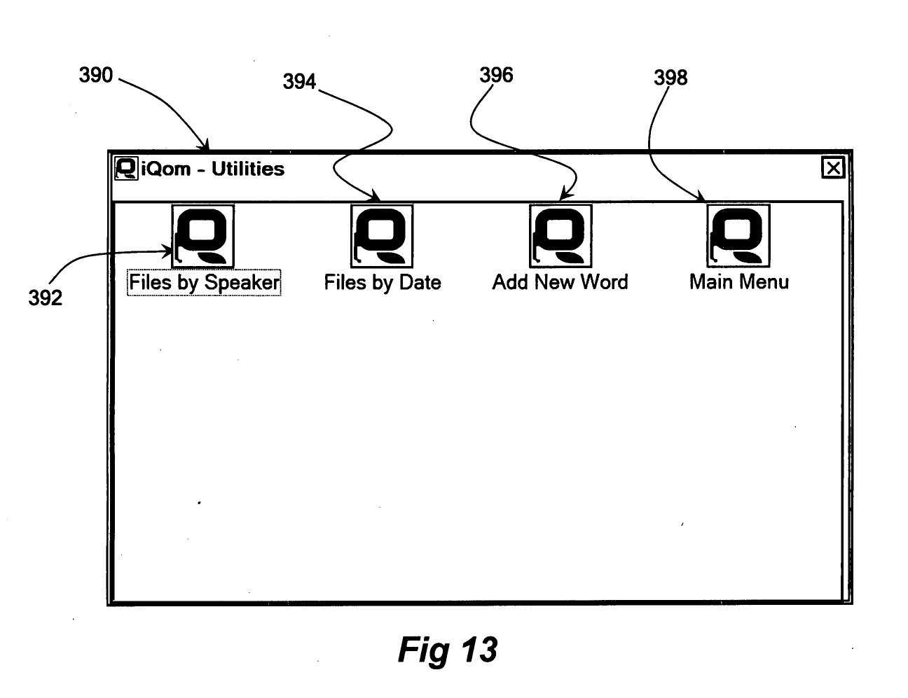

A sample Utilities screen is shown generally at 390 in FIG. 13. The Utilities screen 390 provides the User with some tools. The User can view text files by Speaker 392 or by date 394 that have been stored on the Unit. The Speaker can add a new word 396 to the system and train the system on that new word. Alternatively the User can return to the Main Menu 398.

Enter the Speaker's name to view a list of all the saved text files for that Speaker or leave blank to view a list of all the text files saved. Preferably input to the name field is done through the on-screen keyboard. The User selects ‘OK’ to see the list or the User selects ‘Cancel’ to return to the Utilities Menu.

Alternatively, enter the date to view a list of all the saved files for that date or leave it blank to see a list of all the saved text files on the Unit. As above, preferably input to the date field is done through the On-screen Keyboard. The User selects ‘OK’ to see the list or the User selects ‘Cancel’ to return to the Utilities Menu.

If a word is being added, the User enters the new word into the dictionary and trains the system for that word. Preferably, input to the new word field is done through the on-screen Keyboard. The User selects ‘OK’ to train the new word or the User selects ‘Cancel’ to return to the Utilities Menu.

To train the system, the User presses the ‘Record pronunciation’ button and pronounces the new word. The User can repeat this multiple times to improve the training. The User may select ‘Delete’ to remove a word from the dictionary or the User may select ‘Cancel’ to return to the Utilities Menu.

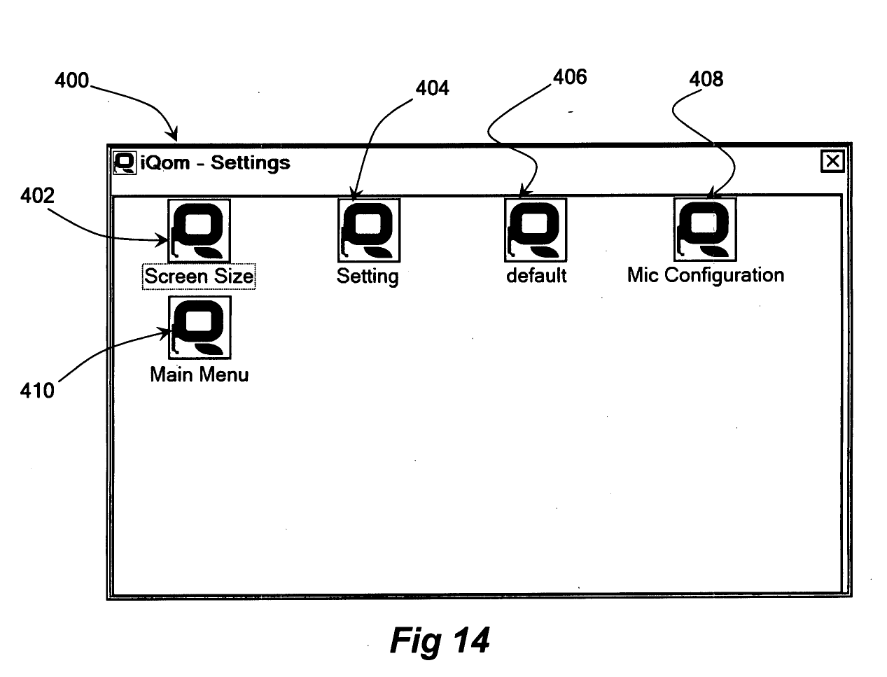

A sample Settings menu is shown generally at 400 in FIG. 14. The User may select ‘Screen Size’ 402 to use an external monitor with the Unit. The User may select ‘Setting’ 404 to launch the speech sensitivity program also shown as part of training a new speaker wizard. The User may select ‘Default’ 406 to set the default preferences that are adopted by all new Speaker Profiles. These settings can be changed for each Speaker in Preferences from the Main Menu to their own requirements and saved as part of their profile. The ‘Mic Configuration’ 408 launches the Microphone Wizard for setting up the microphone. Follow the on screen instructions. Selecting ‘Main Menu’ 410 returns the User to the Main Menu.

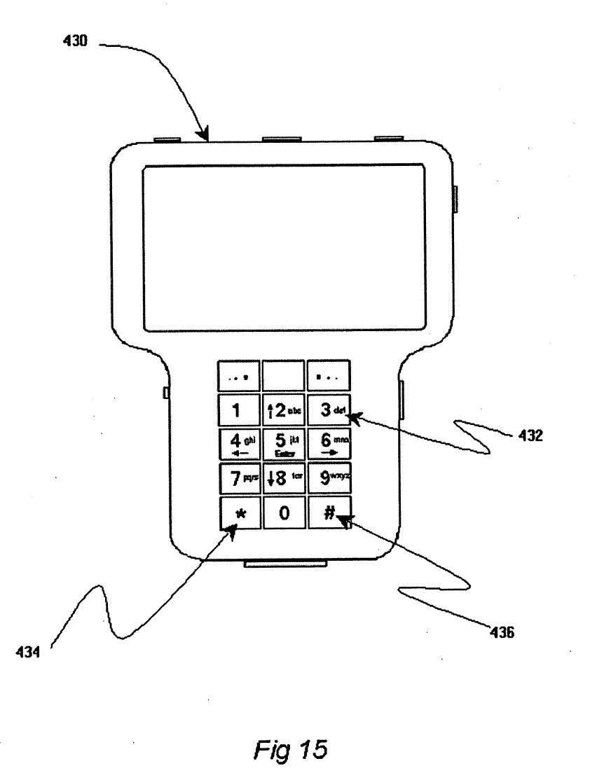

Referring to FIG. 15 an alternate embodiment of the hand held assistive device of the present invention is shown generally at 430. This embodiment is similar to that shown in FIG. 1 but it has a navigation system similar to that found on many phones. The navigation system includes keys 432 for the numbers 0 to 9 and letters are associated with each key. As well there are keys for “*” and “#”, 434 and 436, respectively.

Generally speaking, the systems described herein are directed to hand held assistive devices. As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to hand held assistive devices.

As used herein, the terms ‘comprises’ and ‘comprising’ are to be construed as being inclusive and open rather than exclusive. Specifically, when used in this specification including the claims, the terms ‘comprises’ and ‘comprising’ and variations thereof mean that the specified features, steps or components are included. These terms are not to be interpreted to exclude the presence of other features, steps or components.

What is claimed as the invention is:

1. A hand held device used for interactively converting a speech into a text with at least one speaker, comprising:
a screen for displaying text;
at least one voice input source for receiving the speech from a single speaker;
a sound processor operably connected to the voice input source;
a storage device capable of storing an operating system, a speech engine, speech-to-text applications and data files;
a power source;
a navigation system; and
a control system operably connected to the screen, each voice input source, the storage device, the power source and the navigation system.

2. The hand held device as claimed in claim 1 wherein the voice input source is chosen from the group consisting of a microphone array, a wireless receiver, an input port and a combination thereof.

3. The hand held device as claimed in claim 2 wherein the input port receives a signal from a peripheral device and wherein the peripheral device is chosen from the group consisting of cell phones, telephones, public address systems, external disc drives, wireless enabled headsets, external microphones, external computers, external networks and a combination thereof.

4. The hand held device as claimed in claim 2 wherein the wireless receiver receives signals from a plurality of wireless microphones.

5. The hand held device as claimed in claim 1 wherein the sound processor is a High-Fidelity sound processor having speech recognition and noise-cancelling characteristics.

6. The hand held device as claimed in claim 1 wherein the screen is a touch screen and wherein the touch screen is capable of providing an input to the navigation system.

7. The hand held device as claimed in claim 1 further including a cooling system capable of dissipating heat generated by the device and having thermal sensing capabilities for controlling the cooling system.

8. The hand held device as claimed in claim 1 wherein the storage device is a flash storage device having a capacity of at least 2 Gb.

9. The hand held device as claimed in claim 1 wherein the control system is a custom operating system controlling a central processing unit where the central processing unit is at least a 1.5 GHz with at least a 32 bit architecture having at least 2 Gb of memory.

10. The hand held device as claimed in claim 8 wherein an operable connection between the storage device and the control system is a high speed BUS having a speed of at least 400 MHz.

11. The hand held device as claimed in claim 1 wherein the device includes a plurality of modes wherein the navigation system further includes a keypad wherein the keypad is capable of switching modes, controlling the operating system, the speech-to-text applications and the voice input source.

12. The hand held device as claimed in claim 11 wherein the navigation system further includes a first and second function switch whereby selected use of the first and the second function switch allow for navigation of the speech-to-text applications.

13. The hand held device as claimed in claim 2 wherein the device include four ports wherein the four ports include an Audio In port, a USB port, a Video Out port and a Charger port.

14. The hand held device as claimed in claim 1 wherein the power source is one of standard batteries, rechargeable batteries and a battery pack.

15. The hand held device as claimed in claim 1 wherein the device is part of one of a cell phone, a personal digital assistant and a music player.

16. A method for using an interactive voice recognition system having an operating system, device drivers, a speech engine and a speech-to-text application for use in a hand held device comprising the steps of:
starting the hand held device and automatically loading the operating system, the device drivers, the speech engine and the speech-to-text application;
receiving at least one speaker profile;
loading speaker preferences associated with the received speaker profile;
detecting speech and converting the speech into a text based on the loaded speaker preferences; and
displaying the text.

17. The method for using an interactive voice recognition system as claimed in claim 16 wherein the step of receiving a speaker profile includes the steps of: selecting an existing profile; creating a new profile; providing a name to identify the new profile; training the system to create the new profile and creating preferences for the new profile.

18. The method for using an interactive voice recognition system as claimed in claim 16 further including a step of identifying further speaker preferences and saving in the speaker preferences wherein the further speaker preferences include at least one of save text and voice on exit and storage duration, display time, font size and style, type of microphone and whether to accept input at start-up, save text and voice on change of speaker and storage duration.

19. The method for using an interactive voice recognition system as claimed in claim 16 wherein the speaker profile is received automatically during loading and the received speaker profile is the profile last used.

20. The method for using an interactive voice recognition system as claimed in claim 16 wherein a plurality of speaker profiles is received and each speaker profile is associated with a separate input device operably attached to the interactive voice recognition system.
